(19) United States
(12) Patent Application Publication
(10) Pub. No.: US 2007/0116183 A1
(43) Pub. Date: May 24, 2007

(54) Tomograph

(76) Inventors: Hironori Ueki, Hachioji (JP); Yasutaka Konno, Kokubunji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/566,205

(22) PCT Filed: Jun. 9, 2004
(86) PCT No.: PCT/JP04/08379

§ 371 Date: Jan. 27, 2006

(30) Foreign Application Priority Data
Jul. 30, 2003 (JP) 2003=203654

(51) Int. Cl. G01D 18/00

(52) U.S. Cl. 378/207

(57) ABSTRACT

The present invention provides a technology for reducing artifacts attributable to the non-linearity in the input-output characteristic of a radiation detector and beam hardening of radiation in a tomograph. The tomograph includes a scanning system that includes a generation means which generates radiation to be irradiated to a subject and a detection means which is opposed to the generation means in order to detect the radiation transmitted by the subject, and a rotation means that rotates the scanning system about the subject, and reconstructs a tomographic image of the subject using a plurality of transmitted images produced by projecting the radiation from a plurality of rotational angular positions while rotating the scanning system about the subject. The tomograph further includes: a first storage means in which measured images that are three or more transmitted images produced by rotating the scanning system about a plurality of phantoms including at least one phantom whose section perpendicular to an axis of rotation of the scanning system has different dimensions in two directions orthogonal to the axis of rotation are stored; a production means that produces calculated images as the transmitted images through calculation; a second storage means in which the produced calculated images are stored; and a correction means that corrects the intensities represented by the transmitted images of the subject according to the measured images and calculated images.

### TECHNICAL FIELD

The present invention relates to a tomograph, or more particularly, to a technology for reducing artifacts in a tomographic image attributable to a change in radiation quality occurring in a subject or the non-linearity in the input-output characteristic of a radiation detector.

### BACKGROUND ART

In tomographs, a reconstructed tomographic image of a subject (hereinafter a reconstructed image) may contain artifacts. The artifacts include a ring artifact that is an annular pattern contained in a reconstructed image, and a dark-band artifact that is a black band-like pattern appearing between images of high-radiation absorbent substances. The major factors of the ring artifact are that the sensitivity of a radiation detector varies from pixel to pixel or the input-output characteristic thereof is not ideal but is non-linear. Moreover, the major factor of the dark-band artifact is that radiation quality changes in a subject (beam hardening). Various methods have been proposed in efforts to minimize the artifacts.

The most typical method of minimizing artifacts is an air calibration method. According to the air calibration method, an air image produced without a subject is produced. A distribution of signal intensities represented by an air image is equivalent to a product of a distribution of intensities of radiation incident on a detector by a distribution of sensitivities exhibited by the detector. Consequently, a projection image signal detected at each of pixels or pixel locations in the detector is divided by an air image signal, whereby the distribution of radiation intensities or the variance of detector sensitivities can be corrected.

As another example of the artifact minimization method, a water correction method has been proposed (refer to, for example, Japanese Patent Application Laid-Open No. 7-171145). The water correction method is a method classified into an extension of the air calibration method, and employs a water image, which is produced by scanning a water phantom shaped like a cylinder or elliptic cylinder, on behalf of the air image. In a case where the radiation absorption dose of the water phantom is close to that of a subject, the water correction method not only provides the same effect of correction as that of the air calibration method but also removes the ring artifact attributable to the non-linear input-output characteristic of a detector or the dark-band artifact attributable to the beam hardening.

As still another example of the artifact minimization method, a phantom calibration method has been proposed (refer to, for example, Japanese Patent Publication No. 61-54412). The phantom calibration method is a method of correcting projection data items of a subject using a predefined transform function. The transform function is a polynomial expression for transforming measured values, which are represented by projection images, into theoretical values. The relationship between the measured values and theoretical values is drawn out in advance using calibration phantoms. The calibration phantoms having various diameters are scanned in order to detect the relationship between the measured values and theoretical values. Consequently, signal intensities represented by the projection images can be calibrated over a wide dynamic range offered by a detector.

### DISCLOSURE OF THE INVENTION

The air calibration method can correct a distribution of intensities of radiation incident on a radiation detector or a variance of sensitivities of the radiation detector, and can greatly minimize the ring artifact. However, the air calibration method cannot correct the non-linear input-output characteristic of the radiation detector and therefore cannot completely remove the ring artifact. Moreover, the dark-band artifact attributable to beam hardening cannot be removed.

The water correction method not only provides the same effect of correction as that of the air calibration method but also has the merit of removing the ring artifact and dark-band artifact attributable to the non-linear input-output characteristic of a detector. However, since the radiation absorption dose of the water phantom cannot be exactly agreed with that of a subject, the precision in removal is low.

The phantom calibration method can calibrate signal intensities, which are represented by projection images, over a wide dynamic range offered by a detector. Compared with the water correction method, the phantom calibration method has the merit of highly precisely removing the ring artifact and dark-band artifact attributable to the non-linear input-output characteristic of a detector. However, the number of samples of measured values must be increased in order to improve the precision in approximation of a polynomial expression. In reality, it is nearly impossible to increase the number of samples. Only four or five samples are used in practice. The precision in approximation of the polynomial expression is therefore low. A reconstructed image having undergone the phantom calibration contains remaining artifacts.

The reason why it is nearly impossible to increase the number of samples is that it is time-consuming and labor-intensive to acquire measured data items. For example, assuming that a head calibration phantom (shaped to be circular in a transaxial direction) is scanned as it is in the related art (Patent Document 2), only one sample of measured data is acquired using one calibration phantom having a certain size. Assuming that a chest calibration phantom (shaped to be non-circular in the transaxial direction) is scanned as it is in the related art, two samples of measured data items are acquired using one calibration phantom having a certain size (by scanning the chest calibration phantom in a major-axis direction and a minor-axis direction). Consequently, in order to acquire many samples, many calibration phantoms having different sizes must be scanned in order to acquire measured data items. It is time-consuming and labor-intensive.

Moreover, in order to acquire the measured data items, the center position of a calibration phantom must be precisely aligned with the center of rotation of a scanning system. It is time-consuming to position the calibration phantom. Furthermore, according to the conventional phantom calibration method, the number of samples detected at both ends of a detector is smaller.

An object of the present invention is to provide a tomographic technology for improving the quality of a reconstructed image, which is produced by a tomograph, while highly precisely minimizing artifacts appearing in the reconstructed image.

The object of the present invention and the novel features thereof will be apparent from the description of the specification and the appended drawings.

In order to accomplish the above object, a tomograph in accordance with the present invention has features described below. Typical examples of the present invention will be described below.

(1) A tomograph includes: a scanning system including a generation means for generating radiation to be irradiated to a subject, and a detection means that is opposed to the generation means in order to detect the radiation transmitted by the subject; and a rotation means for rotating the scanning system about the subject. The tomograph reconstructs a tomographic image of the subject on the basis of a plurality of transmitted images produced by projecting the radiation from a plurality of rotational angular positions while rotating the scanning system about the subject. Herein, the tomograph further includes: a first storage means in which measured images that are three or more transmitted images produced by rotating the scanning system about a plurality of phantoms including at least one phantom whose section perpendicular to an axis of rotation of the scanning system has different dimensions in two directions orthogonal to the axis of rotation are stored; a production means for producing calculated images as the transmitted images through calculation; a second storage means in which the produced calculated images are stored; and a correction means for correcting intensities, which are represented by the transmittance images of the subject, according to the measured images and calculated images.

(2) In the tomograph set forth in item (1), the section of the at least one phantom perpendicular to the axis of rotation is substantially elliptic.

(3) In the tomograph set forth in item (1) or (2), the section of at least one of the plurality of phantoms perpendicular to the axis of rotation is shaped substantially like a circle whose center is not aligned with the axis of rotation.

(4) A tomograph includes: a scanning system including a generation means for generating radiation to be irradiated to a subject and a detection means that is opposed to the generation means in order to detect the radiation transmitted by the subject; and a rotation means for rotating the scanning system about the subject. The tomograph reconstructs a tomographic image of the subject using a plurality of transmitted images produced by projecting the radiation from a plurality of rotational angular positions while rotating the scanning system about the subject. Herein, the tomograph further includes: a first storage means in which measured images that are three or more transmitted images produced by rotating the scanning system about a plurality of phantoms including at least one phantom whose section perpendicular to an axis of rotation of the scanning system is shaped substantially like a circle whose center is not aligned with the axis of rotation are stored; a production means for producing calculated images as the transmitted images through calculation; a second storage means in which the produced calculated images are stored; and a correction means for correcting intensities, which are represented by the transmitted images of the subject, according to the measured images and calculated images.

(5) In the tomograph set forth in item (4), the section of at least one of the plurality of phantoms perpendicular to the axis of rotation is substantially elliptic.

(6) In the tomograph set forth in item (4), the section of at least one of the plurality of phantoms perpendicular to the axis of rotation is shaped substantially like a circle whose center is substantially aligned with the axis of rotation.

(7) The tomograph set forth in item (1) or (4) further includes a phantom position calculation means for calculating the center position of a section of a phantom and an inclination of the phantom with respect to a direction parallel to the section according to the tomographic image of the phantom reconstructed based on the measured images. The production means determines a direction of projection, in which the radiation is projected in order to produce the calculated images, according to the center position and inclination.

(8) In the tomograph set forth in item (7), the phantom position calculation means calculates the center position of a section of a phantom according to the barycentric position in a distribution of signal intensities represented by a tomographic image of the phantom.

(9) In the tomograph set forth in item (7), the phantom position calculation means calculates the inclination of a phantom with respect to a direction parallel to a section of the phantom by performing linear approximation on a distribution of signal intensities represented by a tomographic image of the phantom.

(10) A tomograph includes: a scanning system including a generation means for generating radiation to be irradiated to a subject and a detection means that is opposed to the generation means in order to detect the radiation transmitted by the subject; and a rotation means for rotating the scanning system about the subject. The tomograph reconstructs a tomographic image of the subject using a plurality of transmitted images produced by projecting the radiation from a plurality of rotational angular positions while rotating the scanning system about the subject. Herein, the tomograph further includes: a first storage means in which measured images that are three or more transmitted images produced by rotating the scanning system about a plurality of phantoms including at least one phantom whose section perpendicular to an axis of rotation of the scanning system has different dimensions in two directions orthogonal to the axis of rotation are stored; a production means for producing calculated images as the transmitted images through calculation; a second storage means in which the produced calculated images are stored; a parameter value derivation means for deriving parameter values to be assigned to an approximation function by fitting the approximation function close to the relationship between the signal intensities represented by the measured images and the signal intensities represented by the calculated images; a third storage means in which the parameter values are stored; and a correction means for correcting the intensities, which are represented by the transmitted images of the subject, according to the measured images and calculated images.

(11) A tomograph includes: a scanning system including a generation means for generating radiation to be irradiated to a subject and a detection means that is opposed to the generation means in order to detect the radiation transmitted by the subject; and a rotation means for rotating the scanning system about the subject. The tomograph reconstructs a tomographic image of the subject using a plurality of transmitted images produced by projecting the radiation from a plurality of rotational angular positions while rotating the scanning system about the subject. Herein, the tomograph further includes: a first storage means in which measured images that are three or more transmitted images produced by rotating the scanning system about a plurality of phantoms including at least one phantom whose section perpendicular to an axis of rotation of the scanning system is shaped substantially like a circle whose center is not aligned with the axis of rotation are stored; a production means for producing calculated images as the transmittance images through calculation; a second storage means in which the produced calculated images are stored; a parameter value derivation means for deriving parameter values to be assigned to an approximation function by fitting the approximation function close to the relationship between the signal intensities represented by the measured images and the signal intensities represented by the calculated images; a third storage means in which the parameter values are stored; and a correction means for correcting the intensities, which are represented by the transmitted images of the subject, according to the measured images and calculated images.

The present invention has the advantages described below.

(a) The number of samples of measured data items that is four or five according to the conventional phantom calibration method is increased to range from six to several thousands. Therefore, the precision in correction to be attained by the phantom calibration method can be improved. This leads to improvement of the quality of a reconstructed image.

(b) Since the radiation attenuation constant of a phantom can be dynamically varied in a rotation direction in which the scanning system is rotated, measured data items falling within a wide dynamic range can be acquired.

(c) Since the radiation attenuation constant of a typical phantom whose section is circular can be dynamically varied in the rotation direction, measured data items falling within a wide dynamic range can be acquired.

(d) Since a phantom need not be precisely positioned relative to the scanning system, the phantom can be readily placed. The work efficiency in proceeding with acquisition of measured data items improves.

(e) Since the center position of a cross section of a phantom can be readily precisely detected, the precision in calibration to be attained by the phantom calibration method improves.

(f) Even when the cross section of a phantom is not circular, the inclination of the phantom with respect to a direction parallel to the section can be readily precisely detected. Therefore, the precision in calibration to be attained by the phantom calibration method improves.

(g) Signal intensities represented by any transmitted images produced during scanning of a subject can be corrected according to the phantom calibration method.

### BRIEF DESCRIPTION OF THE DRAWINGS

FIG. 1 is a front view illustrating a tomograph in accordance with the first embodiment of the present invention;

FIG. 2 is an explanatory diagram showing a preprocessing means included in the tomograph in accordance with the first embodiment of the present invention;

FIGS. 3 include explanatory diagrams showing the structures of data items stored in the preprocessing means included in the tomograph in accordance with the first embodiment of the present invention;

FIG. 4 is an explanatory diagram showing a correction table creating means included in the tomograph in accordance with the first embodiment of the present invention;

FIG. 5 is an explanatory diagram concerning a correction table creation method implemented in the tomograph in accordance with the first embodiment of the present invention;

FIG. 6 is an explanatory diagram showing a signal intensity correction means included in the tomograph in accordance with the first embodiment of the present invention;

FIGS. 7 include explanatory diagrams concerning a calculation method implemented in a simulation image generating means included in the tomograph in accordance with the first embodiment of the present invention;

FIG. 8 is an explanatory diagram showing a calibration phantom position detecting means included in the tomograph in accordance with the first embodiment of the present invention;

FIG. 9 is an explanatory diagram concerning a method of positioning a plurality of elliptic phantoms in the tomograph in accordance with the first embodiment of the present invention;

FIGS. 10 include explanatory diagrams concerning a calculation method implemented in a simulation image generating means included in a tomograph in accordance with the second embodiment of the present invention;

FIG. 11 is an explanatory diagram concerning a method of positioning a plurality of cylindrical phantoms in the tomograph in accordance with the second embodiment of the present invention;

FIGS. 12 include explanatory diagrams showing an example of another calibration phantom to be disposed in the tomograph in accordance with the embodiment of the present invention; and

FIGS. 13 include explanatory diagrams showing an example of an effect of image improvement attained in the tomograph in accordance with the first embodiment of the present invention.

### BEST MODE FOR CARRYING OUT THE INVENTION

Embodiments of the present invention will be described below in conjunction with the drawings.

### First Embodiment

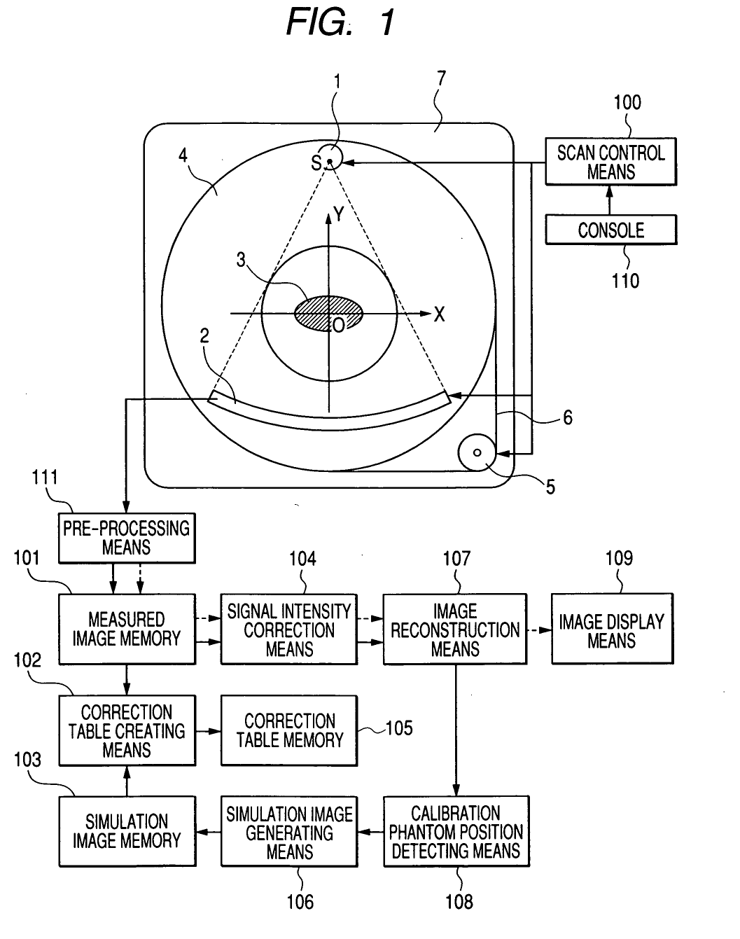

FIG. 1 is a front view illustrating a tomograph in accordance with the first embodiment of the present invention. The tomograph in accordance with the first embodiment includes an X-ray tube 1, an X-ray detector 2, a rotary panel 4, a driving motor 5, a driving belt 6, a gantry 7, a scan control means 100, a preprocessing means 111, a measured image memory 101, a correction table creating means 102, a simulation image memory 103, a signal intensity correction means 104, an image reconstruction means 107, a calibration phantom position detecting means 108, an image display means 109, and a console 110.

Hereinafter, the assembly of the X-ray tube 1 and X-ray detector 2 shall be called a scanning system. The scanning system is fixed to the rotary panel 4. The driving motor 5 rotates the rotary panel 4 and entire scanning system via the driving belt 6. The scanning system irradiates X-rays to a subject 3 from all around the subject, and produces X-ray transmitted images of the subject. An axis of rotation of the rotary panel 4 (not shown) shall be regarded as a Z axis. Moreover, coordinate axes extending horizontally or vertically from an origin that is the center of rotation O of the rotary panel 4 shall be regarded as X and Y axes respectively. An XYZ coordinate system defined with the X, Y, and Z axes is a orthogonal coordinate system.

Referring to FIG. 1, a distance of an X-ray focal spot S in the X-ray tube 1 from the center of rotation O is typically 690 mm. Moreover, a distance of an X-ray incidence surface of the X-raydetector 2 from the center of rotation O is typically 380 mm. A time required for the rotary panel 4 to make one rotation is typically 0.5 sec.

A known multi-slice X-ray detector formed with ceramic scintillators and photodiodes is adopted as the X-ray detector 2. The X-ray detector 2 is comprised of numerous detector elements (not shown). The number of detector elements juxtaposed in the XY plane direction (a direction of channels) is 896, and the number of detector elements juxtaposed in the Z-axis direction (a direction of slices) is 32. The detector elements are disposed in the form of an arc substantially equidistantly from the X-ray focal spot S. The incidence surface of each detector element is typically 1 mm long in both the directions of channels and slices. The number of projections to be achieved during one rotation of the scanning system is typically 900. Every time the rotary panel 4 is rotated 0.4°, one projection is performed.

Next, actions to be performed in the tomograph in accordance with the first embodiment will be described below. The tomograph supports two imaging modes, that is, an actual imaging mode and a calibration imaging mode. An operator uses the console 110 to select either of the actual imaging mode and calibration imaging mode. In FIG. 1, arrows drawn with dashed lines indicate a flow of data treated in the actual imaging mode, while arrows drawn with solid lines indicate a flow of data treated in the calibration imaging mode.

The actions to be performed in the tomograph in the actual imaging mode will be described below. First, an operator uses the console 110 to instruct initiation of a scan. The scan control means 100 initiates the rotation of the rotary panel 4 via the driving motor 5. When the rotation of the rotary panel 4 enters a constant-speed state, the scan control means 100 designates the timing of irradiating X-rays from the X-ray tube 1 and the timing of projecting transmitted X-rays on the X-ray detector 2, and acquires projection data items from all around the subject 3. Thereafter, the preprocessing means 111 performs preprocessing, which includes offset correction, air calibration, and logarithmic conversion, on the projection data items according to a method that will be described later. The projection data items having undergone the preprocessing (hereinafter, measured images) are stored in the measured image memory 101. Thereafter, the signal intensity correction means 104 reads the measured images from the measured image memory 101, and corrects the signal intensities represented by the measured images according to a method that will be described later. The signal intensity correction means 104 references a correction table stored in advance in the correction table memory 105 so as to perform predetermined correction using the correction table. The correction table will be detailed later. Thereafter, the image reconstruction means 107 uses a known technology to reconstruct a tomographic image of the subject 3 according to the output values sent from the signal intensity correction means 104. The reconstructed tomographic image is finally displayed on the image display means 109.

Next, actions to be performed in the tomograph in the calibration imaging mode will be described. In the calibration imaging mode, a calibration phantom to be described later is disposed on behalf of the subject 3. First, the calibration phantom is scanned according to the same procedure as the procedure in the actual imaging mode, and projection data items are preprocessed. The preprocessed projection data items (hereinafter, calibration measured images) are stored in the measured image memory 101. Thereafter, the calibration measured images are read by the signal intensity correction means 104. The signal intensity correction means 104 checks the correction table memory 105 to see if the correction table memory 105 holds a correction table. If the correction table is present, the correction table is referenced in order to correct the signal intensities represented by the calibration measured images. If the correction table is absent, the correction of the signal intensities represented by the calibration measured images is omitted. Thereafter, the image reconstruction means 107 uses a known technology to reconstruct a tomographic image of the calibration phantom according to the output values provided by the signal intensity correction means 104. Thereafter, the calibration phantom position detecting means 108 uses the tomographic image to calculate the position of the calibration phantom on the XY plane according to a method to be described later. Thereafter, the simulation image generating means 106 uses the calculated position of the calibration phantom to calculate theoretic values (hereinafter simulation images or calculated images) from the projection data items acquired from the calibration phantom, and stores the results of the calculation in the simulation image memory 103. Thereafter, the correction table creating means 102 uses the calibration measured images stored in the measured image memory 101 and the simulation images stored in the simulation image memory 103 to create correction table data, based on which the signal intensities represented by measured images are converted into theoretical values, according to a method to be described later, and stores the results of creation in the correction table memory 105. If an old correction table data is stored in the correction table memory 105, the old correction table data is overwritten with the new correction table data.

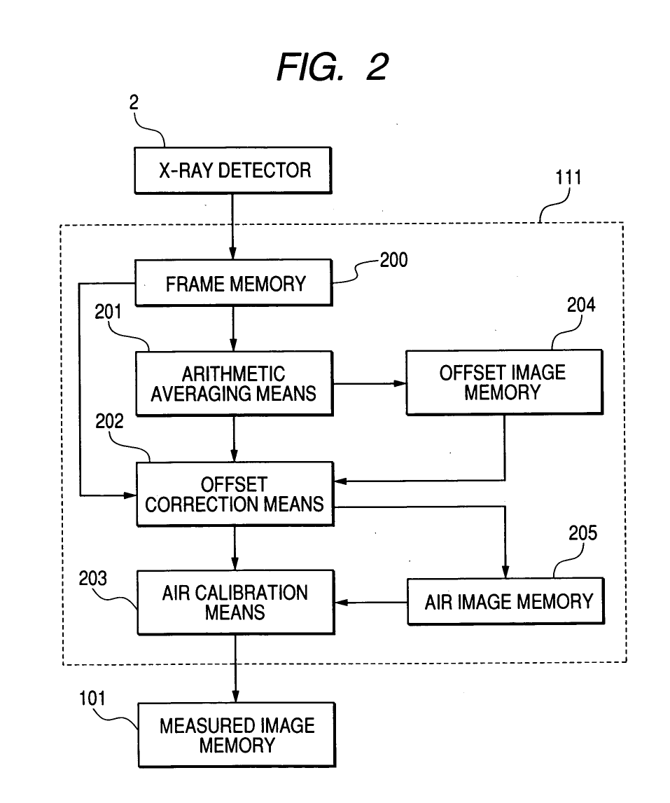

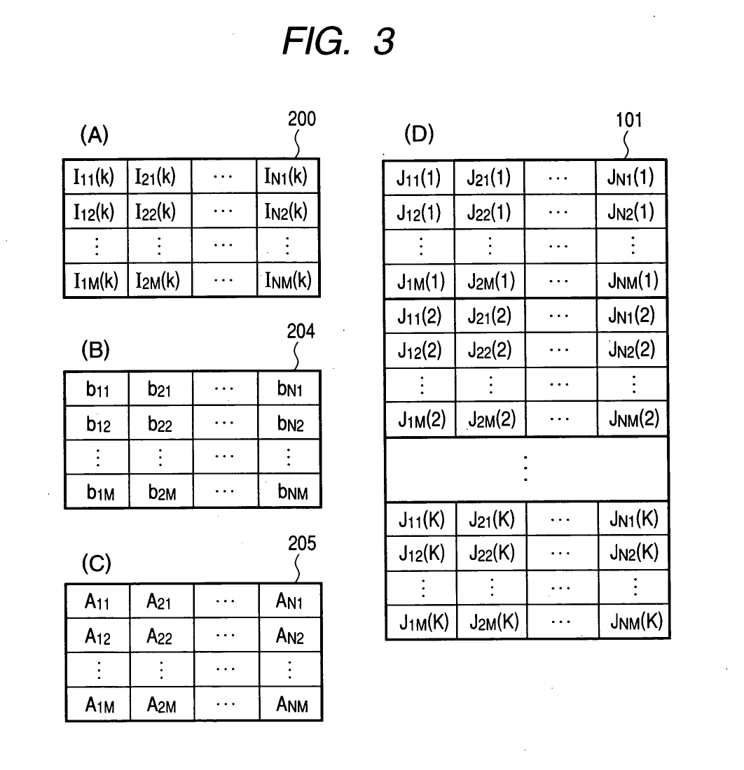

FIG. 2 is an explanatory diagram showing the preprocessing means included in the tomograph in accordance with the first embodiment of the present invention. FIGS. 3 are explanatory diagrams showing the structure of data items to be treated by the preprocessing means 111 included in the tomograph in accordance with the first embodiment of the present invention. Referring to FIG. 2 and FIGS. 3, a procedure to be followed by the preprocessing means 111 will be described below.

The X-ray detector 2 is a multi-slice detector, and has 896 detector elements juxtaposed in the direction of channels and 32 detector elements juxtaposed in the direction of slices. Hereinafter, N and M shall denote the numbers of detector elements juxtaposed in the respective directions of channels and slices. As mentioned above, 900 projections are taken during one rotation of the scanning system. Hereinafter, K shall denote the number of projections. Moreover, Iₙₘ(k) shall denote a detection signal produced by a detector element belonging to the n-th channel and the m-th slice (n ranges from 1 to N, and m ranges from 1 to M) in the X-ray detector 2 during the k-th projection (k ranges from 1 to K).

The preprocessing means 11 performs three pieces of processing, that is, offset image creation, air image creation, and air calibration. The offset image creation and air image creation are designated for an offset image scan or air image scan that precedes a scan of the subject 3. The air calibration is designated for the scan of the subject 3. The three pieces of processing will be described below.

The offset image creation is to create an average image using K offset images produced by performing an offset image scan (a scan not accompanied by irradiation from the X-ray tube 1). Every time one scan is performed, the offset images are sequentially written over old data items in the frame memory 200. The frame memory 200 has a data structure shown in FIG. 3A, and has projection data items that number a product of N by M and that are equivalent to one frame data to be provided by the X-ray detector 2. As soon as the offset images are stored in the frame memory 200, an arithmetic averaging means 201 reads the offset images one after another and averages them according to the formula (1).

$${b}_{nm} = \frac{1}{K} {\sum }_{k = 1}^{K} {I}_{nm} ( k ) ( n = 1 ∼ N , m = 1 ∼ M ) \qquad formula ( 1 )$$

The average offset image produced by the arithmetic averaging means 201 is stored in the offset image memory 204. The offset image memory 204 has a data structure shown in FIG. 3B, and has average offset images that number a product of N by M and that are equivalent to one frame data to be provided by the X-ray detector 2.

The air image creation is to create an average image using K air images produced by performing an air image scan (a scan performed without the subject 3 by irradiating X-rays from the X-ray tube 1). The air images are sequentially written over old images in the frame memory 200. As soon as the air images are stored in the frame memory 200, the arithmetic averaging means 201 reads the air images sequentially and averages them according to the formula (2).

$${A}_{nm }^{′} = \frac{1}{K} {\sum }_{k = 1}^{K} {I}_{nm} ( k ) ( n = 1 ∼ N , m = 1 ∼ M ) \qquad formula ( 2 )$$

As soon as the arithmetic averaging means 201 calculates an average air image, the offset correction means 202 reads the average air image and compensates an offset according to the formula (3).
Aₙₘ=A′ₙₘ−bₙₘ (n=1˜N, m=1˜M) formula (3)

In the above arithmetic operation, an average offset image stored in the offset image memory 204 is referenced. The average air image having an offset compensated by the offset correction means 202 is stored in the air image memory 205. The air image memory 205 has a data structure shown in FIG. 3C, and has average air images that number a product of N by M and that are equivalent to one frame data to be provided by the X-ray detector 2.

The air calibration is performed on projection images of the subject in order to correct the spatial distribution of X-ray energy spectrum radiated from the X-ray tube 1 or the distribution of sensitivities exhibited by the X-ray detector 2. Every time one scan is performed the projection images are successively written on old images in the frame memory 200. As soon as the projection images are stored in the frame memory 200, the offset correction means 200 reads the projection images from the frame memory 200 and compensates an offset of each image compensated according to the formula (4).
I′ₙₘ(k)=Iₙₘ(k)−bₙₘ (n=1˜N, m=1˜M, k=1˜K) formula (4)

The offset correction means 202 reads the projection data items directly from the frame memory 200 but does not read the projection data items via the arithmetic averaging means 201. In the above arithmetic operation, the average offset images stored in the offset image memory 204 are referenced. As soon as the offsets of the projection images are compensated by the offset correction means 202, the air calibration means 203 reads the projection images having the offsets compensated, and performs air calibration according to the formula (5).

$${J}_{nm} ( k ) = ln \frac{{A}_{nm}}{{I}_{nm}^{′} ( k )} ( n = 1 ∼ N , m = 1 ∼ M , k = 1 ∼ K ) \qquad formula ( 5 )$$

In the above arithmetic operation, the average air images stored in the air image memory 205 are referenced. The projection images having been calibrated by the air calibration means 203 are stored in the measured image memory 101. The foregoing series of arithmetic operations performed during air calibration is performed every time the projection images are stored in the frame memory 200, and is therefore repeated K times. The measured image memory 101 has a data structure shown in FIG. 3D, and holds projection images which number a product of N by M by K and which are equivalent to K frame data items to be provided by the X-ray detector 2.

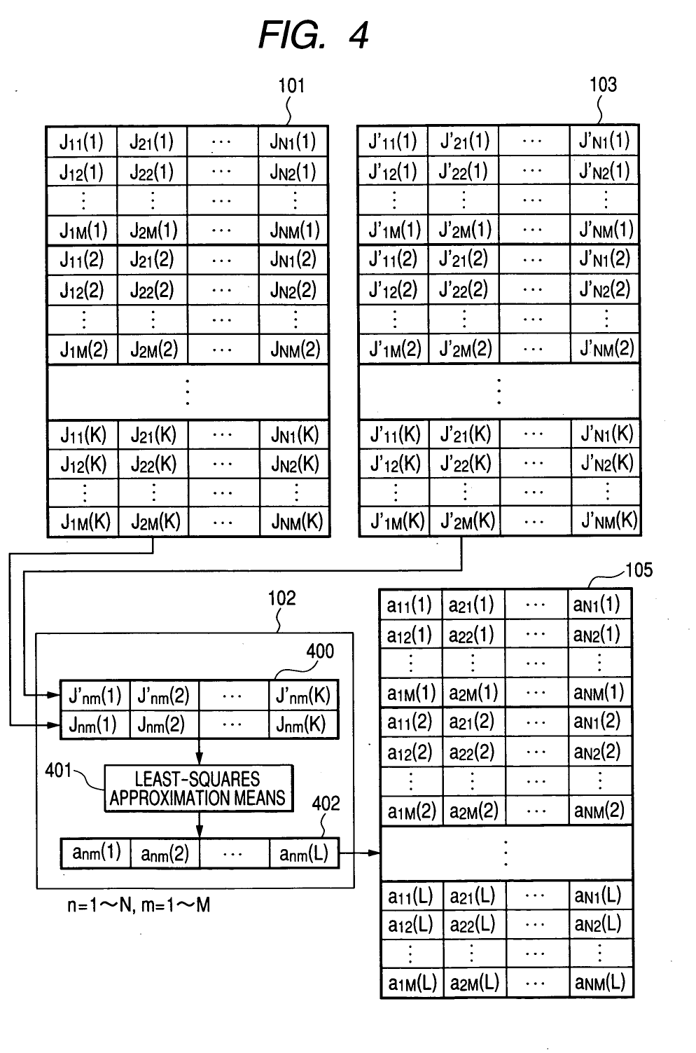

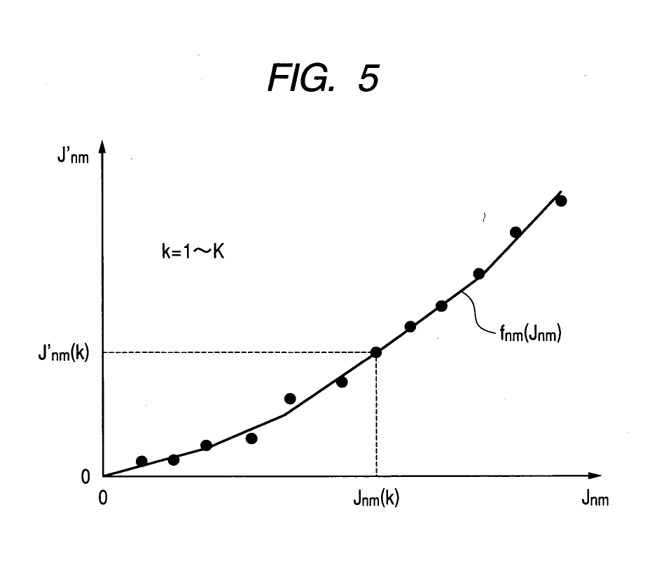

FIG. 4 is an explanatory diagram showing the correction table creating means 102 included in the tomograph in accordance with the first embodiment of the present invention. FIG. 5 is an explanatory diagram concerning a correction table creation method implemented in the tomograph in accordance with the first embodiment of the present invention. Referring to FIG. 4 and FIG. 5, a procedure to be followed by the correction table creating means 102 will be described below.

As mentioned above, the correction table creating means 102 is used in the calibration imaging mode. In the calibration imaging mode, a calibration phantom to be described later is disposed on behalf of the subject 3. Projection data items of the calibration phantom are acquired. After the preprocessing means 111 performs air calibration on the projection data items, the projection data items are stored in the measured image memory 101. The data items stored in the measured image memory 101 and simulation image memory 103 share the same data structure. All the projection data items (measured images ), Jₙₘ(k) (where n ranges from 1 to N, m ranges from 1 to M, and k ranges from 1 to K), having undergone the air calibration are stored in the measured image memory 101. On the other hand, theoretical values (simulation images or calculated images) J′ₙₘ(k) (where n ranges from 1 to N, m ranges from 1 to M, and k ranges from 1 to K) which the simulation image generating means 106 has calculated from the projection data items are stored in the simulation image memory. The method of calculating the simulation images J′ₙₘ(k) will be described later. The measured images and simulation images are ideally consistent with one another but actually inconsistent with one another. This is because radiation quality changes in a subject (beam hardening) due to the non-linear input-output characteristic of the X-ray detector 2 and the energy spectrum of X-ray radiated from the X-ray tube 1. The non-linear relationship between the measured images and theoretical values may cause the ring artifact and dark-band artifact to appear in a reconstructed tomographic image and therefore must be corrected to be linear. The correction table creating means 102 creates a correction table based on which the non-linear relationship is corrected.

The relationship between the measured images Jₙₘ(k) and the simulation images J′ₙₘ(k) can be approximated by a polynomial expression or any other function. FIG. 5 graphically shows polynomial approximation. For the polynomial approximation, the axis of abscissas reads the values represented by the measured images Jₙₘ(k) and the axis of ordinates reads the values represented by the simulation images J′ₙₘ(k). A curve is plotted based on points of all k values ranging from 1 to K. Thereafter, the curve is approximated by the polynomial function presented as the formula (6) below.
J′ₙₘ(k)=aₙₘ(L)Jₙₘ^{L}+aₙₘ(L−1)J_{n772 m}^{L-1}+ . . . +aₙₘ(l)Jₙₘ (n=1˜N, m−1˜M) formula (6)

Incidentally, a known technology such as the least squares method is employed for the approximation. A predetermined value is adopted as the degree L of the polynomial function. However, when the degree L is 1, since the polynomial function is a linear function, the polynomial function cannot express the non-linear relationship between the measured images and theoretical values. Consequently, the degree L must be 2 or larger. For precise approximation of the non-linear relationship, the degree L should preferably be 3 or larger. When the degree L is 3, the polynomial expression includes three coefficients aₙₘ(1), aₙₘ(2), and aₙₘ(3) according to the formula (6). In order to calculate the three coefficients using the least squares method, the number of projections K must be 3 or more. In general, the number of projections K should be equal to or larger than the degree L of the polynomial function. The coefficients aₙₘ(L), aₙₘ(L−1), etc., and aₙₘ(1) are derived from the foregoing processing, and listed in the form of a correction table.

In order to create the correction table, the correction table creating means 102 first reads the measured images Jₙₘ(k), which are acquired during all of the k-th projections ranging from the first projection to the K-th projection, and the simulation images J′ₙₘ(k) , which are produced from the measured images, from the measured image memory 101 and simulation image memory 103 respectively, and writes them in a buffer memory 400. Thereafter, a least squares approximation means 401 reads the data items from the buffer memory 400 and performs the polynomial approximation according to the formula (6). The obtained coefficients aₙₘ(L), aₙₘ(L−1), etc., and aₙₘ(1) are stored in the correction table memory 105. This sequence is repeated in order to treat all data items produced by all detector pixel locations (n,m) (where n ranges from 1 to N and m ranges from 1 to M). The least squares approximation means 401 is realized by software installed in a dedicated or general-purpose computing device.

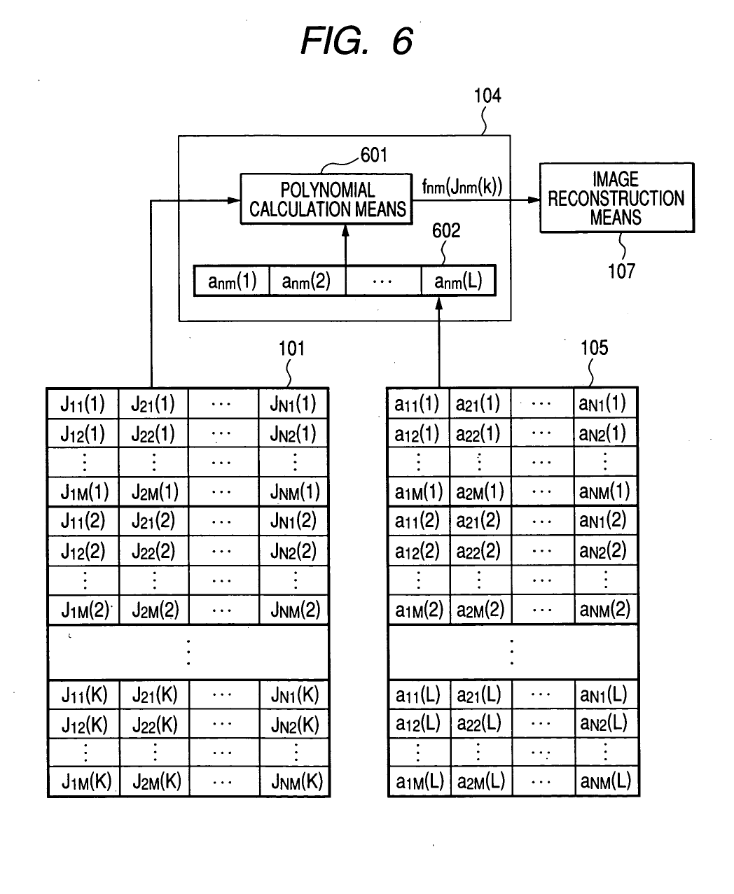

FIG. 6 is an explanatory diagram concerning the signal intensity correction means 104 included in the tomograph in accordance with the first embodiment of the present invention. The preprocessing means 111 performs air calibration on projection images of the subject 3 acquired in the actual imaging mode. The resultant projection images are stored in the measured image memory 101. The air calibration is performed every time projection images are detected by the X-ray detector 2. The projection data items Jₙₘ(k) (where n ranges from 1 to N and ranges from 1 to M) produced by performing air calibration on projection images equivalent to the k-th frame (where k ranges from 1 to K) are written in the measured image memory 101. Every time the writing is completed, a polynomial calculation means 601 reads the coefficients aₙₘ(L), aₙₘ(L−1), etc., and aₙₘ(1) of a polynomial expression, which are associated with data items detected at each detector pixel location (n,m), from the correction table memory 105, and stores them in a buffer memory 602. Moreover, the polynomial calculation means 601 reads the projection data items Jₙₘ(k) that have undergone the air calibration, and the coefficients aₙₘ(L), aₙₘ(L−1), etc., and aₙₘ(1) of a polynomial expression from the measured image memory 101 and buffer memory 602 respectively, and solves the formula (6) to work out fₙₘ(Jₙₘ(k)) for the purpose of signal intensity correction. The signal intensity correction is repeatedly performed in order to correct signal intensities represented by projection data items detected by all detector pixel locations (n,m) (where n ranges from 1 to N and m ranges from 1 to M). The results are transferred to an image reconstruction means 107. The polynomial calculation means 601 is realized by software installed in a dedicated or general-purpose computing device.

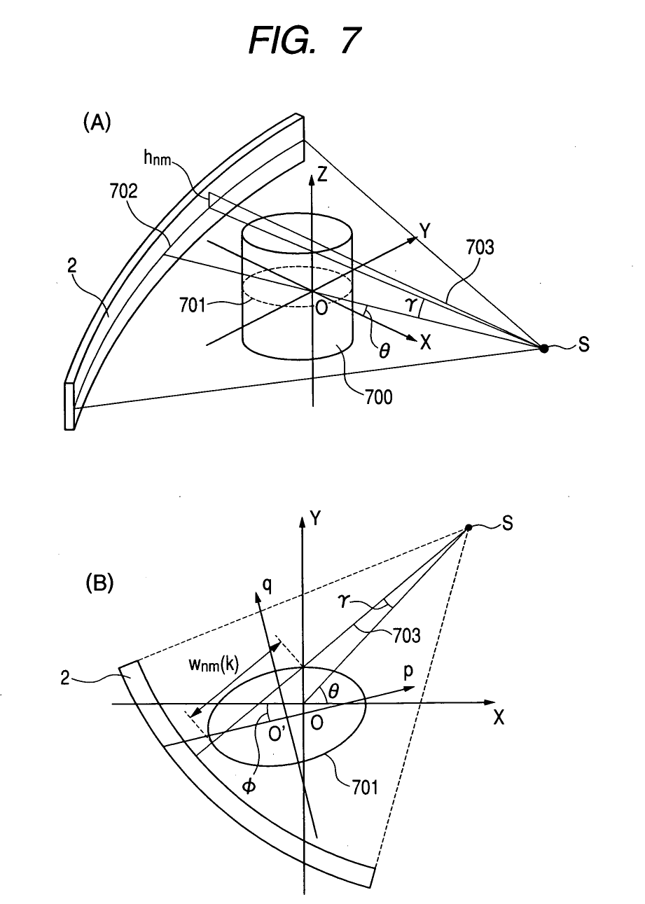

FIGS. 7 are explanatory diagrams concerning a calculation method implemented in the simulation image generating means 106 included in the tomograph in accordance with the first embodiment of the present invention. In particular, a method of producing simulation images in a case where an elliptic phantom 700 is adopted as the calibration phantom will be described in conjunction with FIG. 7A and FIG. 7B. An orthogonal coordinate system XYZ shown in FIG. 7A is a stationary coordinate system defined in the gantry 7. The X-ray focal spot S is rotated on the XY plane, and the center of rotation is consistent with the origin O of the XYZ coordinate system. The XY plane meets the X-ray detector 2 along a line of intersection 702. The elliptic phantom 700 is shaped like an elliptic cylinder and disposed so that the longitudinal direction thereof will substantially be aligned with the Z axis. The material of the elliptic phantom 700 is typically polyethylene but may be any other material such as an acrylic acid resin. Hereinafter, 2a, 2b, and H shall denote the outer dimensions of the elliptic phantom 700 in the major-axis direction, minor-axis direction, and longitudinal direction. The 2a, 2b, and H values are typically 350 mm, 200 mm, and 300 mm respectively. A line of intersection 701 along which the elliptic phantom 700 meets the XY plane depicts an ellipse.

As shown in FIG. 7B, a pq coordinate system is a coordinate system defined in the elliptic phantom 700, and the origin of the coordinate system is regarded as the center of an ellipse O′ expressed with the line of intersection 701. Moreover, p and q axes shall extend in the directions of the major and minor axes of the substantial ellipse depicted by the line of intersection 701. The elliptic phantom 700 is disposed so that the center point O′ of the ellipse will be located near the origin O of the XYZ coordinate system and the p axis will be substantially aligned with the X axis. However, it is generally hard to dispose the phantom precisely. The position (O′x,O′y) of the center O′ of the ellipse on the XY plane does not fully correspond to a point (0,0). Moreover, an angle φ at which the p axis meets the X axis is not exactly 0. The parameter (O′x,O′y) and angle φ that define the position of the elliptic phantom 700 are autonomously detected by the calibration phantom position detecting means 108 according to a method to be described later.

The simulation image generating means 106 calculates theoretical values J′ₙₘ(k) from projection data items Jₙₘ(k) (where n ranges from 1 to N and m ranges from 1 to M) that have undergone air calibration and are produced from the projection images equivalent to the k-th frame (wherein k ranges from 1 to K). The theoretical values J′ₙₘ(k) are provided as the formula (7).
J′ₙₘ(k)=μₚwₙₘ(k) (n=1˜N, m=1˜M) formula (7)
where wₙₘ(k) denotes a distance by which the X-ray beam 703 that is radiated from the X-ray focal spot S during the k-th projection and falls on a detector pixel location (n,m) on the X-ray detector 2 has passed through the elliptic phantom 700. Moreover, μₚ denotes an X-ray absorption coefficient exhibited by the elliptic phantom 700. Assuming that y denotes an angle of radiation at which the X-ray beam 703 meets the direction of channels, hₙₘ denotes the distance of the detector pixel location (n,m) from the line of intersection 702, d denotes the distance between the X-ray focal spot S and the center of rotation O, and D denotes the distance between the X-ray focal spot S and the incidence surface of the X-ray detector 2, the passed distance wₙₘ(k) is provided as the formula (8).

$${w}_{nm} ( k ) = \frac{2 a b \sqrt{{b}^{2} {t}_{p}^{2} + {a}^{2} {t}_{q}^{2} - {( {t}_{p} {S}_{q} - {t}_{q} {S}_{p} )}^{2}}}{{b}^{2} {t}_{p}^{2} + {a}^{2} {t}_{q}^{2}} ( n = 1 ∼ N , m = 1 ∼ M ) \qquad formula ( 8 )$$

where Sₚ and S_{q} denote p- and q-coordinates defined in the pq coordinate system in order to represent the position of the X-ray focal spot S, and are expressed by the formulae (9) and (10) respectively.
Sₚ=(d cos θₖ−O′ₓ) cos φ+(d sin θₖ−O′_{y}) sin φ formula (9)
S_{q}=−(d cos θₖ−O′ₓ) sin φ+(d sin θₖ−O′_{y}) cos φ formula (10)

In the formula (8), tₚ and t_{q} denote p-axis and q-axis components of a unit vector representing the direction of the X-ray beam 703, and are expressed by the formulae (11) and (12) respectively.

$$\begin{matrix}{t}_{p} = \frac{- D}{\sqrt{{D}^{2} + {h}_{nm}^{2}}} cos ( ϕ + γ - {θ}_{k} ) & formula ( 11 ) \\ {t}_{q} = \frac{- D}{\sqrt{{D}^{2} + {h}_{nm}^{2}}} sin ( ϕ + γ - {θ}_{k} ) & formula ( 12 )\end{matrix}$$

In the formulae (9) to (12), θₖ denotes a rotational angle by which the X-ray focal spot S is angularly separated from the X axis during the k-th projection, and is expressed by the formula (13).

$${θ}_{k} = 2 π \frac{k - 1}{K} ( k = 1 ∼ K ) \qquad formula ( 13 )$$

The simulation image generating means 106 uses the formulae (7) to (13) to calculate theoretical values J′ₙₘ(k) from projection images detected at all pixel locations (n,m), where n ranges from 1 to N and m ranges from 1 to M, during all of the k-th projections where k ranges from 1 to K. The results of the calculation are stored in the simulation image memory 103. The simulation image generating means 106 is realized by software installed in a dedicated or general-purpose computing device.

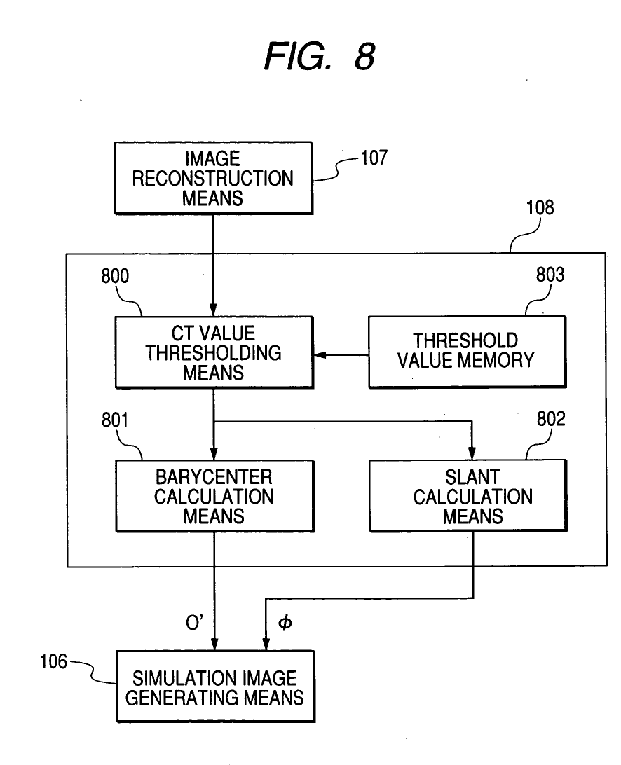

FIG. 8 is an explanatory diagram showing the calibration phantom position detecting means 108 included in the tomograph in accordance with the first embodiment of the present invention. As already described, the elliptic phantom 700 is disposed so that the center position O′ will be nearly consistent with the center O of the XY plane. However, the center position O′ need not be highly precisely consistent with the center O, as long as a deviation of the center position O′ from the center O falls within several centimeters. Since such rough precision is permitted, man-hours required for disposition of the calibration phantom are reduced. The calibration phantom position detecting means 108 autonomously detects a deviation of the position of the elliptic phantom 700 caused by the above disposition. The positional deviation is determined with the center position O′ on the elliptic phantom 700 and an inclination φ at which the major axis of the elliptic phantom 700 (p axis) meets the X axis. The detected O′ and φ values are referenced by the simulation image generating means 106.

A CT value thresholding means 800 reads a CT reconstructed image of the elliptic phantom 700 from the image reconstruction means 107. Hereinafter, signal values representing the CT reconstructed image shall be defined as signal values R(i,j). i and j denote pixel locations in the X axis direction and the Y axis direction, respectively, in the reconstructed image (where i ranges from 1 to I and j ranges from 1 to J) . The CT value thresholding means 800 references a threshold Rₜ recorded in advance in a threshold memory 803, and compares the threshold Rt with the signal values R(i,j) . If Rₜ<R(i,j) is established, the signal values R(i,j) are replaced with 1s. If R(i,j)<Rₜ is established, the signal values R(i,j) are replaced with 0s. Incidentally, the threshold Rₜ is re-set to an intermediate value between a CT number exhibited by image data representing the internal region of the elliptic phantom and a CT number exhibited by image data representing the external region thereof. Consequently, the portion of a CT reconstruction image binary-coded by the CT value thresholding means 800 which shows the internal region of the elliptic phantom is represented by 1s, the portion thereof which shows the external region thereof is represented by 0s. The binary-coded CT reconstructed image is read by each of a barycenter calculation means 801 and a slant calculation means 802. The barycenter calculation means 801 is a means for calculating a barycentric position in the elliptic phantom 700. The barycentric position is consistent with the center position 0′ of the elliptic phantom 700, and is calculated according to the formula (14) below.

$${O}^{′} = ( {O}_{x}^{′} , {O}_{y}^{′} ) = ( \frac{{\sum }_{i = 1}^{I} {\sum }_{j = 1}^{J} R ( i , j ) {X}_{i}}{{\sum }_{i = 1}^{I} {\sum }_{j = 1}^{J} R ( i , j )} , \frac{{\sum }_{i = 1}^{I} {\sum }_{j = 1}^{J} R ( i , j ) {Y}_{i}}{{\sum }_{i = 1}^{I} {\sum }_{j = 1}^{J} R ( i , j )} ) \qquad formula ( 14 )$$

where Xᵢ and Yᵢ denote X- and Y-coordinates defined in the XY coordinate system in order to represent the position of a pixel (i,j). The slant calculation means 802 is a means for calculating an inclination φ at which the major axis of the elliptic phantom 700 meets the X axis. The slant calculation means 802 performs linear approximation on the pixels (Xᵢ,Yᵢ) represented by the signal values R(i,j) of 1s according to the formula (15).
Y=AX+B formula (15)

At this time, the inclination φ is calculated according to the formula (16).
φ=tan⁻¹ A formula (16)

Incidentally, a known technology such as the least squares method is adopted for the linear approximation. Moreover, the calibration phantom position detecting means 108 is realized by software installed in a dedicated or general-purpose computing device.

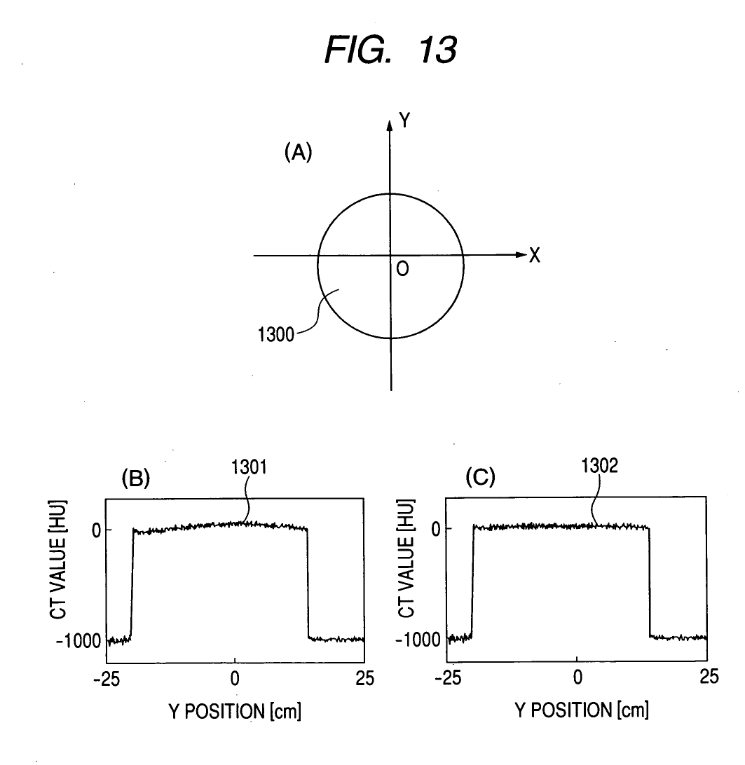

FIGS. 13 are explanatory diagrams concerning an effect of improvement in image quality exerted by the tomograph in accordance with the first embodiment of the present invention. Above all, FIG. 13A illustrates how to dispose an assessment subject 1300. FIG. 13B and FIG. 13C show profiles indicating CT numbers, which are represented by a reconstructed image in cases where calibration is not performed or performed, in relation to positions on the Y axis. The assessment subject 1300 is a water phantom shaped like a cylinder of 350 mm in diameter. For a scan, the tube voltage of the X-ray tube 1 is set to 120 kV, the tube current thereof is set to 200 mA, and the other scanning conditions are identical to those described in relation to the first embodiment. In the case where calibration is not performed, the profile 1301 expresses poor homogeneity. A maximum difference of a CT number from another is 59 HU. In contrast, in the case where calibration is performed, the profile 1302 expresses excellent homogeneity. The maximum difference of a CT number from another is 4.8 HU. Consequently, according to the present invention, the precision in deriving CT numbers represented by a reconstructed image improves, and image quality improves.

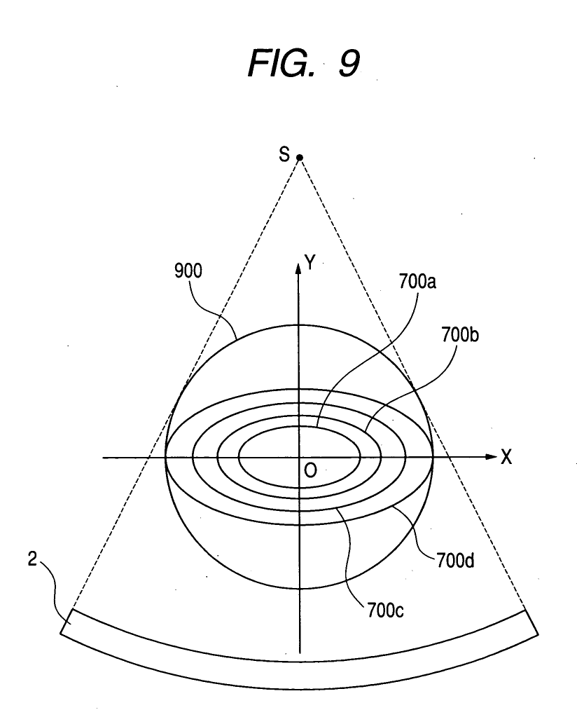

The tomograph in accordance with the first embodiment has been described so far. The present invention is not limited to the first embodiment but can be modified in various manners without a departure from the gist. For example, according to the first embodiment, the elliptic phantom 700 is limited to one size. Alternatively, as shown in FIG. 9, a plurality of elliptic phantoms 700a to 700d having different sizes may be used to create a correction table. However, the elliptic phantoms 700a to 700d shall be disposed so that the center positions thereof will be located near the center of rotation o in the scanning system. Moreover, the elliptic phantoms 700a to 700d shall be disposed so that they will fully fall within a field of view 900 determined by the X-ray detector 2. Furthermore, the correction table creating means 102 performs polynomial approximation on calibration measured images, which are acquired from the elliptic phantoms 700a to 700d, and simulation images according to the formula (6), and stores the calculated coefficients aₙₘ(L), aₙₘ(L−1), etc., and aₙₘ(1) in the correction table memory 105.

### Second Embodiment

A tomograph in accordance with the second embodiment of the present invention will be described below. The tomograph in accordance with the second embodiment of the present invention uses a cylindrical phantom 1000 on behalf of the elliptic phantom 700 employed as a calibration phantom in the first embodiment. The other components of the tomograph are identical to those of the first embodiment described in conjunction with FIG. 1 to FIG. 6. An iterative description will be omitted.

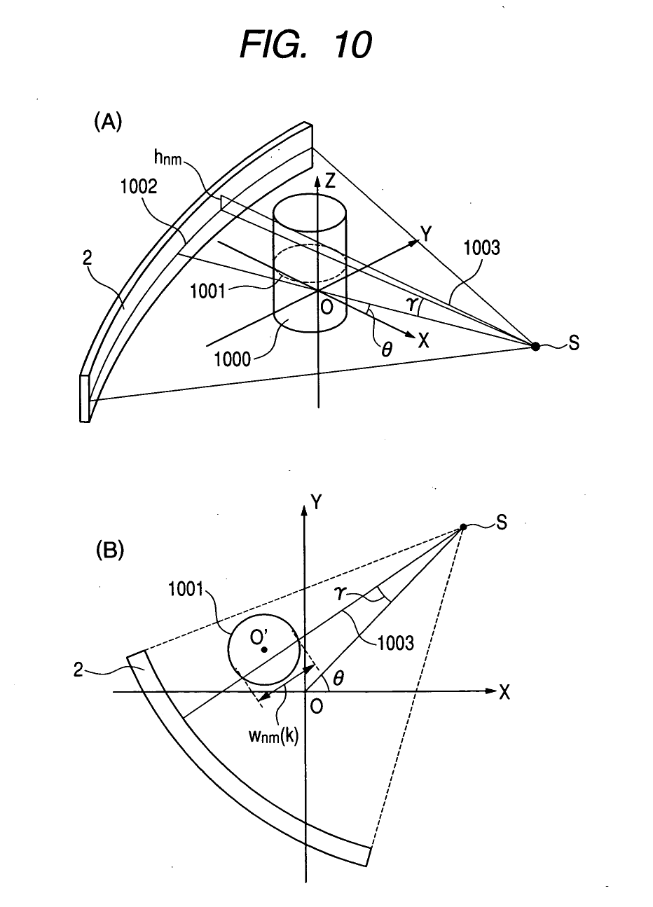

FIGS. 10 are explanatory diagrams concerning a calculation method implemented in the simulation image generating means 106 included in the tomograph in accordance with the second embodiment of the present invention. Referring to FIGS. 10, a simulation image generation method will be described on the assumption that the cylindrical phantom 1000 is adopted as a calibration phantom. As already described, the orthogonal coordinate system XYZ is a stationary coordinate system defined in the gantry 7. The X-ray focal spot S is rotated on the XY plane, and the center of rotation is consistent with the origin O of the XYZ coordinate system. The XY plane meets the X-ray detector 2 along a line of intersection 1002. The cylindrical phantom 1000 has a cylindrical shape and is disposed so that the longitudinal direction thereof will substantially be aligned with the Z axis. The cylindrical phantom 1000 is made of a substantially homogeneous material at a substantially uniform density. The material of the cylindrical phantom 1000 is typically polyethylene. Alternatively, any other material such as an acrylic resin may be substituted for the polyethylene. Hereinafter, 2r and H shall denote the outer diameter and height of the cylindrical phantom 1000 respectively. The 2r and H values are typically 250 mm and 300 mm.

The line of intersection 1001 along which the cylindrical phantom 1000 meets the XY plane depicts substantially a circle, and the center of the circle shall be a point O′. The cylindrical phantom 1000 is disposed so that the center point O′ of the substantial circle will be located at a position (O′x,O′y) different from a point on an axis of rotation, that is, the origin O of the XYZ coordinate system.

The parameter value (O′x,O′y) representing the position of the cylindrical phantom 1000 is autonomously detected by the calibration phantom position detecting means 108. The calibration phantom position detecting means 108 autonomously detects the center point O′ according to the same method as the method described in conjunction with FIG. 8. However, when the cylindrical phantom 1000 is an object of tomography, unlike when the elliptic phantom 700 is employed, the inclination φ need not be detected. Consequently, calculation to be performed by the slant calculation means 802 is omitted. Only the center point O′ detected by the barycenter calculation means 801 is referenced by the simulation image generating means 106.

The simulation image generating means 106 calculates theoretical values J′ₙₘ(k) from projection data items Jₙₘ(k) (where n ranges from 1 to N and m ranges from 1 to M) that are produced from projection images equivalent to the k-th frame (where k ranges from 1 to K) and that have undergone air calibration. The theoretical values J′ₙₘ(k) are expressed as the formula (17).
J′ₙₘ(k)=μ_{q}wₙₘ(k) (n=1˜N, m=1˜M) formula (17)
where Wₙₘ(k) denotes a distance by which an X-ray beam 1003 that is radiated from the X-ray focal spot S during the k-th projection and falls on a detector pixel location (n,m) on the X-ray detector 2 passes through the cylindrical phantom 1000. Moreover, μ_{q} denotes an X-ray absorption coefficient exhibited by the cylindrical phantom 1000. Assuming that γ denotes an angle of radiation at which the X-ray beam 1003 meets the direction of channels, hₙₘ denotes a distance of the detector pixel location (n,m) from the line of intersection 1002, d denotes a distance between the X-ray focal spot S and the center of rotation O, and D denotes a distance between the X-ray focal spot S and the incidence surface of the X-ray detector 2, the passed distance wₙₘ(k) is provided as the formula (18).

$${w}_{nm} ( k ) = \frac{2 \sqrt{( {t}_{x}^{2} + {t}_{y}^{2} ) {r}^{2} - ( {t}_{x} {S}_{y}^{′} - {t}_{y} {S}_{x}^{′} )}}{{t}_{x}^{2} + {t}_{y}^{2}} ( n = 1 ∼ N , m = 1 ∼ M ) \qquad formula ( 18 )$$

where S′ₓ and S′_{y} are expressed as the formulae (19) and (20) respectively.
S′ₓ=d cos θₖ−O′ₓ formula (19)
S′_{y}=d sin θₖ−O′_{y} formula (20)

In the formula (18), tₓ and t_{y} denote X- and Y-axis components of a unit vector representing the direction of the X-ray beam 1003, and are expressed as the formulae (21) and (22) respectively.

$$\begin{matrix}{t}_{x} = \frac{- D}{\sqrt{{D}^{2} + {h}_{nm}^{2}}} cos ( γ - {θ}_{k} ) & formula ( 21 ) \\ {t}_{y} = \frac{D}{\sqrt{{D}^{2} + {h}_{nm}^{2}}} sin ( γ - {θ}_{k} ) & formula ( 22 )\end{matrix}$$

In the formulae (19) to (22), θₖ denotes a rotational angle by which the X-ray focal spot S is angularly separated from the X axis during the k-th projection, and is expressed as the formula (13). The simulation image generating means 106 uses the formulae (17) to (22) to calculate the oretical values J′ₙₘ(k) from projection images detected at all pixel locations (n,m), where n ranges from 1 to N and m ranges from 1 to M, during k-th projections where k ranges from 1 to K. The results of the calculation are stored in the simulation image memory 103. The simulation image generating means 106 is realized by software installed in a dedicated or general-purpose computing device.

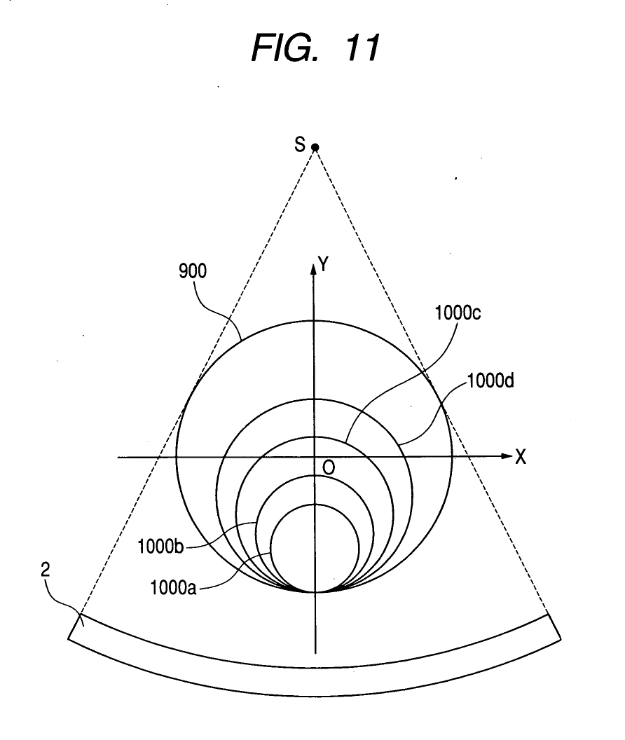

The tomograph in accordance with the second embodiment has been described so far. Needless to say, the present invention is not limited to the second embodiment but can be modified in various manners without a departure from the gist thereof. For example, according to the second embodiment, the cylindrical phantom 1000 is limited to one size. Alternatively, a plurality of cylindrical phantoms 1000a to 1000d having different sizes as shown in FIG. 11 may be used to create a correction table. However, the cylindrical phantoms 1000a to 1000d shall be disposed so that the peripheries thereof will be substantially inscribed to the field of view 900 determined by the X-ray detector 2. However, all the cylindrical phantoms 1000a to 1000d shall be disposed to fully fall within the field of view 900 determined by the X-ray detector 2. Moreover, the correction table creating means 102 performs polynomial approximation on calibration measured images, which are acquired from all the cylindrical phantoms 1000a to 1000d, and simulation images according to the formula (6), and stores calculated coefficients aₙₘ(L), aₙₘ(L−1), etc., and aₙₘ(1) in the correction table memory 105.

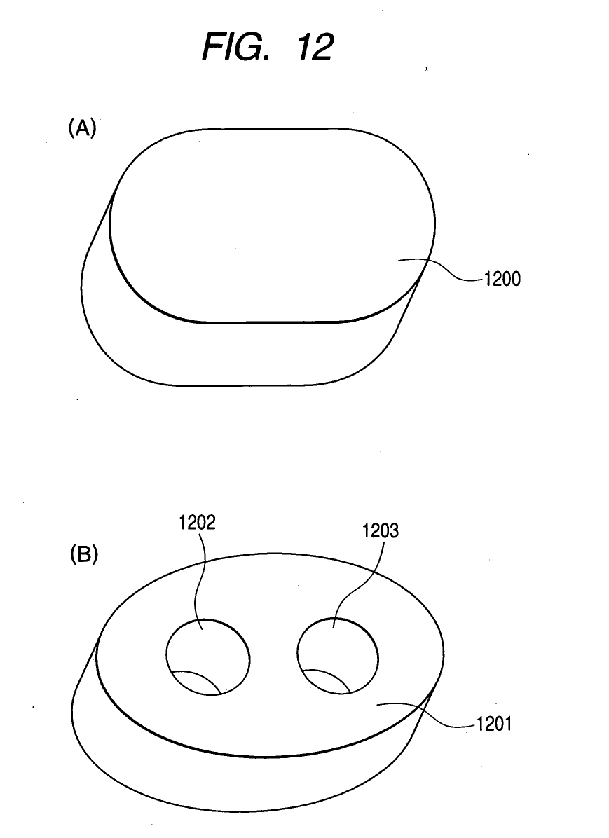

In the aforesaid first and second embodiments, the elliptic phantom 700 or cylindrical phantom 1000 is adopted as a calibration phantom.. However, the calibration phantom is not limited to these types. For example, an abdominal phantom 1200 simulating the human abdomen as shown in FIG. 12A or a chest phantom 1201 simulating the human chest as shown in FIG. 12B may be adopted. Herein, the chest phantom 1201 has holes 1202 and 1203 bored in order to simulate the lung fields of a human body. When the shape of the calibration phantom resembles the shape of the subject that is an object of tomography, the number of scattered X-rays produced during a scan of the calibration phantom becomes close to the number of scattered X-rays produced during a scan of the subject 3. Therefore, the precision in correction to be performed by the signal intensity correction means 104 improves.

In the first and second embodiments, one calibration phantom of a certain shape is employed. The phantoms employed in the first and second embodiments respectively may be used in combination in order to acquire calibration measured images, and the calibration measured images and simulation images produced from the calibration measured images may be used to create the correction table 105.

Moreover, the phantoms employed in the first and second embodiments respectively may be used in combination with various calibration phantoms of other different shapes or sizes (including a phantom whose section perpendicular to an axis of rotation is substantially circular and which is substantially aligned with the axis of rotation) in order to acquire calibration measured images, and the calibration measured images and simulation images produced from the calibration measured images may be used to create the correction table 105.

As described so far, the present invention realizes a tomographic technology for acquiring many samples of measured data items from a calibration phantom by performing simple measurement according to a phantom calibration method. Consequently, the precision in polynomial approximation based on the phantom calibration method improves, and the quality of a reconstructed image improves.

### INDUSTRIAL APPLICABILITY

According to the present invention, artifacts appearing in a reconstructed image produced by a tomograph are reduced to improve the quality of the reconstructed image.

1. A tomograph including a scanning system that includes a generation means for generating radiation to be irradiated to a subject, and a detection means opposed to the generating means in order to detect the radiation transmitted by the subject, and a rotation means for rotating the scanning system about the subject, and reconstructing a tomographic image of the subject using a plurality of transmitted images produced by projecting the radiation from a plurality of rotational angular positions while rotating the scanning system about the subject, comprising:
a first storage means in which measured images that are three or more transmitted images produced by rotating the scanning system about a plurality of phantoms including at least one phantom whose section perpendicular to an axis of rotation of the scanning system has different dimensions in two directions orthogonal to the axis of rotation are stored;
a production means for producing calculated images as the transmitted images through calculation;
a second storage means in which the produced calculated images are stored; and
a correction means for correcting intensities, which are represented by the transmitted images of the subject, according to the measured images and calculated images.

2. The tomograph according to claim 1, wherein the section of the at least one phantom perpendicular to the axis of rotation is substantially elliptic.

3. The tomograph according to claim 1, wherein the section of at least one of the plurality of phantoms perpendicular to the axis of rotation is shaped substantially like a circle, and the center of the circle is not aligned with the axis of rotation.

4. The tomograph according to claim 2, wherein the section of at least one of the plurality of phantoms perpendicular to the axis of rotation is shaped substantially like a circle, and the center of the circle is not aligned with the axis of rotation.

5. A tomograph including a scanning system that includes a generation means for generating radiation to be irradiated to a subject, and a detection means opposed to the generating means in order to detect the radiation transmitted by the subject, and a rotation means for rotating the scanning system about the subject, and reconstructing a tomographic image of the subject using a plurality of transmitted images produced by projecting the radiation from a plurality of rotational angular positions while rotating the scanning system about the subject, comprising:
a first storage means in which measured images that are three or more transmitted images produced by rotating the scanning system about a plurality of phantoms including at least one phantom whose section perpendicular to an axis of rotation of the scanning system is shaped substantially like a circle whose center is not aligned with the axis of rotation are stored;
a production means for producing calculated images as the transmitted images through calculation;
a second storage means in which the produced calculated images are stored; and
a correction means for correcting intensities, which are represented by the transmitted images of the subject, according to the measured images and calculated images.

6. The tomograph according to claim 5, wherein the section of at least one of the plurality of phantoms perpendicular to the axis of rotation is substantially elliptic.

7. The tomograph according to claim 5, wherein the section of at least one of the plurality of phantoms perpendicular to the axis of rotation is shaped substantially like a circle, and the center of the circle is substantially aligned with the axis of rotation.

8. The tomograph according to claim 1, further comprising a phantom position calculation means for calculating the center position of a section of a phantom and an inclination of the phantom with respect to the direction parallel to the section according to the tomographic image of the phantom reconstructed based on the measured images, wherein:
the production means determines a direction of projection, in which the radiation is projected in order to produce the calculated images, according to the center position and inclination.

9. The tomograph according to claim 5, further comprising a phantom position calculation means for calculating the center position of a section of a phantom and an inclination of the phantom with respect to the direction parallel to the section according to the tomographic image of the phantom reconstructed based on the measured images, wherein:
the production means determines a direction of projection, in which the radiation is projected in order to produce the calculated images, according to the center position and inclination.

10. The tomograph according to claim 8, wherein the phantom position calculation means calculates the center position of a section of a phantom according to the barycentric position in a distribution of signal intensities represented by the tomographic image of the phantom.

11. The tomograph according to claim 9, wherein the phantom position calculation means calculates the center position of a section of a phantom according to the barycentric position in a distribution of signal intensities represented by the tomographic image of the phantom.

12. The tomograph according to claim 8, wherein the phantom position calculation means calculates the inclination of a phantom with respect to the direction parallel to the section of the phantom by performing linear approximation on a distribution of signal intensities represented by the tomographic image of the phantom.

13. The tomograph according to claim 9, wherein the phantom position calculation means calculates the inclination of a phantom with respect to the direction parallel to the section of the phantom by performing linear approximation on a distribution of signal intensities represented by the tomographic image of the phantom.

14. A tomograph including a scanning system that includes a generation means for generating radiation to be irradiated to a subject, and a detection means opposed to the generating means in order to detect the radiation transmitted by the subject, and a rotation means for rotating the scanning system about the subject, and reconstructing a tomographic image of the subject using a plurality of transmitted images produced by projecting the radiation from a plurality of rotational angular positions while rotating the scanning system about the subject, comprising:
a first storage means in which measured images that are three or more transmitted images produced by rotating the scanning system about a plurality of phantoms including at least one phantom whose section perpendicular to an axis of rotation of the scanning system has different dimensions in two directions orthogonal to the axis of rotation are stored;
a production means for producing calculated images as the transmitted images through calculation;
a second storage means in which the produced calculated images are stored;
a parameter value derivation means for deriving parameter values to be assigned to an approximation function by fitting the approximation function close to the relationship between the signal intensities represented by the measured images and the signal intensities represented by the calculated images;
a third storage means in which the parameter values are stored; and
a correction means for correcting intensities, which are represented by the transmitted images of the subject, according to the measured images and calculated images.

15. A tomograph including a scanning system that includes a generation means for generating radiation to be irradiated to a subject, and a detection means opposed to the generating means in order to detect the radiation transmitted by the subject, and a rotation means for rotating the scanning system about the subject, and reconstructing a tomographic image of the subject using a plurality of transmitted images produced by projecting the radiation from a plurality of rotational angular positions while rotating the scanning system about the subject, comprising:
a first storage means in which measured images that are three or more transmitted images produced by rotating the scanning system about a plurality of phantoms including at least one phantom whose section perpendicular to an axis of rotation of the scanning system is shaped substantially like a circle whose center is not aligned with the axis of rotation are stored;
a production means for producing calculated images as the transmitted images through calculation;
a second storage means in which the produced calculated images are stored;
a parameter value derivation means for deriving parameter values to be assigned to an approximation function by fitting the approximation function close to the relationship between the signal intensities represented by the measured images and the signal intensities represented by the calculated images;
a third storage means in which the parameter values are stored; and
a correction means for correcting intensities, which are represented by the transmitted images of the subject, according to the measured images and calculated images.
